(19) United States
(12) Patent Application Publication
(10) Pub. No.: US 2022/0237002 A1
(43) Pub. Date: Jul. 28, 2022

(54) Scheduling of Application Preloading

(71) Applicant: TENSERA NETWORKS LTD., Hod Hasharon (IL)

(72) Inventors: Ehud Weinstein, Tel Aviv (IL); Amit Wix, Raanana (IL); Roee Peled, Ramat Gan (IL)

(21) Appl. No.: 17/582,025

(22) Filed: Jan. 24, 2022

Related U.S. Application Data
(60) Provisional application No. 63/142,512, filed on Jan. 28, 2021.

(51) Int. Cl. G06F 9/445; G06F 12/123; G06F 12/02

(52) U.S. Cl. CPC G06F 9/44578; G06F 12/0246; G06F 12/123

(57) ABSTRACT

A user device includes an output device and one or more processors. The one or more processors are configured to run an Operating System (OS), to query a component of the OS that possesses information indicative of a user application that the user is currently expected to access, and to preload the user application in a background mode that is unnoticeable on the output device.

### CROSS-REFERENCE TO RELATED APPLICATIONS

This application claims the benefit of U.S. Provisional Patent Application 63/142,512, filed Jan. 28, 2021, whose disclosure is incorporated herein by reference.

### FIELD OF THE INVENTION

The present invention relates generally to handling of user applications in user devices, and particularly to methods and systems for preloading of applications and content.

### BACKGROUND OF THE INVENTION

In applications (“apps”) that run on user devices such as smartphones, one of the major factors affecting user experience is the latency of the User Interface (UI). Various techniques have been proposed for reducing latency and providing a more responsive UI. Some techniques involve prefetching of content. Other techniques involve background preloading of apps. Yet other techniques involve pre-rendering of an app's UI.

### SUMMARY OF THE INVENTION

An embodiment of the present invention that is described herein provides a user device including an output device and one or more processors. The one or more processors are configured to run an Operating System (OS), to query a component of the OS that possesses information indicative of a user application that the user is currently expected to access, and to preload the user application in a background mode that is unnoticeable on the output device.

In an embodiment, the OS component is a component that presents to the user a list of suggested user applications, and the user application is one of the suggested user applications. In a disclosed embodiment, the OS component is a memory management component of the OS that tracks Least-Recently Used (LRU) user applications, and the user application is one of the LRU user applications that meets a defined criterion. In an example embodiment, the OS component is a component that prefetches content for user applications, and the user application is one of the user applications for which content is prefetched by the OS component.

There is additionally provided, in accordance with an embodiment of the present invention, a user device including a memory and one or more processors. The one or more processors are configured to detect unused memory space that is available in the memory, and to preload one or more user applications to exploit at least some of the unused memory space in the memory. In some embodiments, the one or more processors are configured to detect the unused memory space by detecting that a user has killed a user application.

There is also provided, in accordance with an embodiment of the present invention, a user device including an output device and one or more processors. The one or more processors are configured to identify a proximity of the user device to a given device or location, and, responsively to the identified proximity, to preload a given user application in a background mode that is unnoticeable on the output device.

In an example embodiment, the one or more processors are configured to identify the proximity by detecting that the user device connects to a trusted peripheral device. In an embodiment, the one or more processors are configured to identify the proximity by detecting that the user device connects to a specified network identity. In a disclosed embodiment, the one or more processors are configured to identify the proximity by querying a geofencing service in the user device.

There is further provided, in accordance with an embodiment of the present invention, a user device including an output device and one or more processors. The one or more processors are configured to define a preloading scheme for a user application installed on the user device, depending on one or both of (i) a rate of change of content used by the user application, and (ii) an amount of processing load incurred by the user application, and to preload the user application, in a background mode that is unnoticeable on the output device, using the defined preloading scheme.

In an embodiment, the one or more processors are configured to preload only a part of the user application in which the rate of change of the content is below a threshold. In a disclosed embodiment, the one or more processors are configured to preload the user application using a combination of an offline preloading mode and an online preloading mode.

In an example embodiment, the user application is characterized by a rate of change higher than a threshold, and the one or more processors are configured to preload only an initialization logic of the user application. In an embodiment, the user application includes an initialization phase whose processing load is above a threshold, and the one or more processors are configured to preload the user application using an offline preloading mode. In an embodiment, the user application is characterized by incremental content updates, and the one or more processors are configured to preload the user application using an online preloading mode. In an example embodiment, the user application includes an offline-first experience, and the one or more processors are configured to preload the user application using an offline preloading mode.

There is also provided, in accordance with an embodiment of the present invention, a user device including a memory and one or more processors. The one or more processors are configured to run an Operating System (OS) including a preload agent and a memory manager. The preload agent is configured to preload user applications. The memory manager is configured to select one or more user applications to be retained in the memory based on, at least in part, preloading capabilities of the OS, and to load the selected user applications to the memory, including, upon deciding to preload a given user application, invoking the preload agent to preload the given user application.

There is additionally provided, in accordance with an embodiment of the present invention, a method including, in a user device that includes an output device and that runs an Operating System (OS), querying a component of the OS, which possesses information indicative of a user application that the user is currently expected to access. The user application is preloaded in a background mode that is unnoticeable on the output device.

There is also provided, in accordance with an embodiment of the present invention, a method including, in a user device, detecting unused memory space that is available in a memory of the user device. One or more user applications are preloaded to exploit at least some of the unused memory space in the memory.

There is further provided, in accordance with an embodiment of the present invention, a method including, in a user device that includes an output device, identifying a proximity of the user device to a given device or location. Responsively to the identified proximity, a given user application is preloaded in a background mode that is unnoticeable on the output device.

There is additionally provided, in accordance with an embodiment of the present invention, a method including, in a user device that includes an output device, defining a preloading scheme for a user application installed on the user device, depending on one or both of (i) a rate of change of content used by the user application, and (ii) an amount of processing load incurred by the user application. The user application is preloaded in a background mode that is unnoticeable on the output device, using the defined preloading scheme.

There is further provided, in accordance with an embodiment of the present invention, a method including, in a user device that includes a memory and runs an Operating System (OS), running in the OS a preload agent that preloads user applications. A memory manager is further run in the OS, including selecting one or more user applications to be retained in the memory based on, at least in part, preloading capabilities of the OS, and loading the selected user applications to the memory, including, upon deciding to preload a given user application, invoking the preload agent to preload the given user application.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a communication system that employs preloading, in accordance with an embodiment of the present invention;

FIGS. 2-4 are flow charts that schematically illustrate method for preload scheduling, in accordance with embodiments of the present invention; and

FIG. 5 is a flow chart that schematically illustrates a method for preloading, in accordance with another embodiment of the present invention.

### DETAILED DESCRIPTION OF EMBODIMENTS

### Definitions

The present disclosure refers to preloading of applications (“apps”) and app components such as User Interface (UI) Displays. In the present context, the term “preloading” refers to the process of loading, launching and at least partially running an app in a background mode unnoticeably to the user, not in response to a request from the user to interact with the app. App components that may be preloaded comprise, for example, the main feed of the app, other UI displays of the app, and/or in-app content, i.e., app content that is not immediately visible to the user upon launching the app. App preloading may involve, for example, pre-rendering of one or more UI displays of the app in the background.

The term “pre-rendering” refers to the process of constructing a UI display of an app in the background mode. Pre-rendering is considered herein to be a component of a preloading operation. Pre-rendering may involve UI tasks that modify the UI display, and/or UI tasks that do not directly modify the UI display but are prerequisite to such modification or are synced to modification of the UI display in the background. Thus, for example, initialization or preparatory tasks that are performed when preloading an app and preparing to initialize or modify a UI display of the app are also regarded herein as pre-rendering tasks.

Certain aspects of preloading and pre-rendering are addressed in PCT International Publication WO 2018/055506, entitled “An Optimized CDN for the Wireless Last Mile,” filed Sep. 19, 2017; in PCT International Publication WO 2019/171237, entitled “Application Preloading in the Presence of User Actions,” filed Mar. 4, 2019; in PCT International Publication WO 2021/161174, entitled “Preloading of Applications and In-Application Content in User Devices,” filed Feb. 10, 2021; in PCT International Publication WO 2021/019415, entitled “Pre-Rendering of Application User-Interfaces in User Devices,” filed Jul. 26, 2020; and in PCT International Publication WO 2019/082042, entitled “Audio Inhibition of Applications in Background Mode, Pre-Loading and Refreshing Thereof,” filed Oct. 21, 2018, whose disclosures are incorporated herein by reference.

The term “UI display” in this context refers to a logical UI element—A view or a window that is used by the app to enable interaction with the user. In the Android Operating System (OS), for example, UI displays are referred to as “views” or “activities.” The description that follows will refer mainly to the Android OS and to activities, by way of example. Activities are commonly maintained in “tasks”. A task typically comprises a container that stores, as a stack, records of activities that users interact with when performing a certain job.

### Overview

When using preloading techniques in a user device, some of the most important decisions are when, and under what conditions, to schedule a preloading operation, and which application or applications to preload. Preloading the right application at the right time and under the right circumstances can lead to enhanced user experience with little or no penalty in other areas. Suboptimal preloading, on the other hand, can waste system resources and fail to provide the desired user experience.

Embodiments of the present invention that are described herein provide improved methods and systems for preloading of user applications (“apps”) and their content in user devices. More specifically, the techniques described herein provide novel criteria for deciding which apps to preload, and under what conditions.

In some embodiments, a user device runs an Operating System (OS) that, among other functions, preloads UI displays and in-app content of user apps. The disclosed techniques can be used for preloading of individual UI displays, of groups of interrelated UI displays, or of entire apps. For the sake of clarity, the description that follows refers mainly to the Android OS and to Android Activities, by way of example. The disclosed techniques, however, are applicable to any other suitable OS and any other suitable type of UI display or other content. The OS component that carries out the various preloading functions is referred to herein as a “preload agent.”

The user device OS typically comprises a memory manager—A software component that decides which apps and what content are most useful to keep in memory, using any suitable algorithm. The memory manager typically attempts to predict the apps and/or content that the user is expected to need next. In some embodiments described herein, the memory manager is configured to take the preload capabilities of the OS into account, so that its selection algorithm may select apps that are not currently alive in memory, and invoke the preload agent to preload chosen apps that are not alive. To this end, the memory manager may query the preload agent to find which apps are preload-capable and to assess the costs associated with preloading each app.

In some disclosed embodiments, the memory manager uses the fact that the OS possesses information indicative of apps that the user is expected (e.g., likely) to access in the near future. In these embodiments, the memory manager queries the existing information in the OS to identify one or more such apps, and then invokes the preload agent to preload them. The memory manager may query, for example, a list of “suggested apps” that the OS presents to the user, a Least-Recently-Used (LRU) memory management mechanism, a prefetch scheduler, or other suitable OS components.

In some embodiments, the memory manager runs an ongoing process of monitoring unused space in the user-device memory, and populating unused memory space with preloaded apps. This process exploits most, if not all, of the unused memory space for improving user experience. In an example embodiment, the memory manager may invoke the preload agent to preload one or more apps in response to detecting that memory space became available in the user device memory. Memory space may become available for various reasons, e.g., due to the OS or user “killing” an app, due to restarting the user device, and the like.

In some embodiments, the OS triggers the preload agent to preload an app in response to detecting that the user device is in proximity to a predefined device. The predefined device may comprise, for example, a wired or wireless peripheral, a predefined network identity, a certain local service, and the like. The app being preloaded is typically an app that is likely to be used by the user when in proximity to the predefined device.

In some embodiments, the preload agent defines a preloading scheme for a specific app in a manner that conserves network and/or user device resources. The preloading scheme may depend on characteristics of the app, such the rate of change of the content used by the app and/or the amount of processing incurred by the app in the user device. The preloading scheme may utilize different reloading modes, e.g., offline and online preloading, as defined below.

### System Description

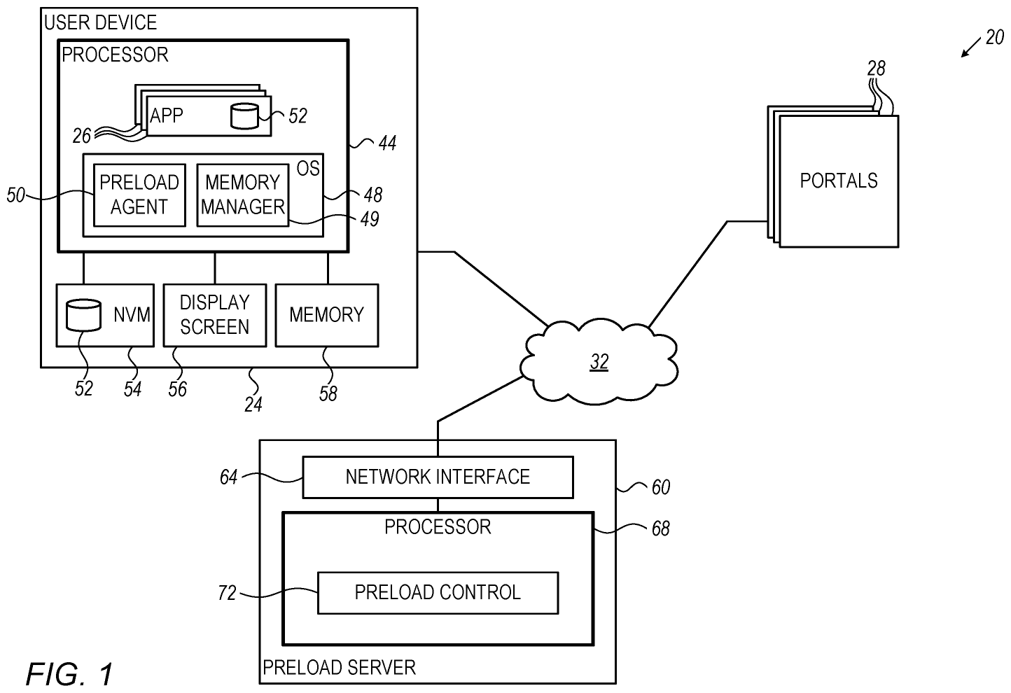

FIG. 1 is a block diagram that schematically illustrates a communication system 20 that employs preloading, in accordance with an embodiment of the present invention.

System 20 comprises a user device 24, which runs one or more user applications (“apps”) 26. Device 24 may comprise any suitable wireless or wireline device, such as, for example, a cellular phone or smartphone, a wireless-enabled laptop or tablet computer, a desktop personal computer, a video gaming console, a smart TV, a wearable device, an automotive user device, or any other suitable type of user device that is capable of presenting content to a user. The figure shows a single user device 24 for the sake of clarity. Real-life systems typically comprise a large number of user devices of various kinds.

In the present context, the terms “user application,” “application” and “app” are used interchangeably, and refer to any suitable computer program that runs on the user device and may be invoked (activated) by the user. Some apps 26 may be dedicated, special-purpose applications such as game apps. Other apps 26 may be general-purpose applications such as Web browsers.

In some embodiments, although not necessarily, apps 26 are provided by and/or communicate with one or more network-side servers, e.g., portals 28, over a network 32. Network 32 may comprise, for example a Wide Area Network (WAN) such as the Internet, a Local Area Network (LAN), a wireless network such as a cellular network or Wireless LAN (WLAN), or any other suitable network or combination of networks.

In the present example, user device 24 comprises a processor 44 that carries out the various processing tasks of the user device. Among other tasks, processor 44 runs an Operating System (OS) 48, which in turn runs apps 26. The embodiments described herein refer mainly to the Android OS. The disclosed techniques, however, are applicable to any other suitable OS that may run on user devices, e.g., iOS, Windows, Linux and the like. OS 48 comprises, among other components (i) a software component referred to as a memory manager 49, which manages the use of memory, and (ii) a software component referred to as a preload agent 50, which handles preloading of apps. Apps 26, OS 48 and preload agent 50 are drawn schematically inside processor 44, to indicate that they comprise software running on the processor.

In addition, user device 24 comprises a Non-Volatile Memory (NVM) 54, e.g., a Flash memory. NVM 54 may serve, inter alia, for storing a cache memory 52 for caching content associated with apps. In some embodiments the user device uses a single cache 52. In other embodiments, also depicted schematically in the figure, a separate cache memory 52 may be defined per app. Hybrid implementations, in which part of cache 52 is centralized and some is app-specific, are also possible. For clarity, the description that follows will refer simply to “cache 52”, meaning any suitable cache configuration.

User device 24 further comprises a display screen 56 for presenting visual content to the user, and an audio output device (e.g., speaker and/or headset output) for sounding audio to the user. Each of screen 56 and the audio output device is also referred to generally as an “output device” of user device 24. User device 24 further comprises a suitable network interface (not shown in the figure) for connecting to network 32. This network interface may be wired (e.g., an Ethernet Network Interface Controller—NIC) or wireless (e.g., a cellular modem or a Wi-Fi modem). User device 24 further comprises a volatile memory 58, e.g., Random Access Memory (RAM), for storing apps, app components, data, and/or any other suitable information.

In the example embodiment of FIG. 1, although not necessarily, system 20 further comprises a preload server 60 that performs preloading-related tasks on the network side. Server 60 comprises a network interface 64 for communicating over network 32, and a processor 68 that carries out the various tasks of the preload server. In the present example, processor 68 runs a preload control unit 72 that carries out network-side preloading-related tasks.

Network-side preloading-related tasks may comprise, for example, deciding which apps to preload and when, choosing whether and which in-app content to preload, deciding how much of an app component to preload (e.g., only executing some initial executable code, or pre-rendering of the app's user interface and/or deciding on the duration of foreground simulation). Another example is a “whitelist” of apps permitted to undergo preloading. In an embodiment, preload server 60 may be implemented as a cloud-based application.

In the embodiments described herein, for the sake of clarity, preloading tasks are described as being carried out by processor 44 of user device 24. Generally, however, preloading tasks may be carried out by processor 44 of device 24, by processor 68 of server 60, or both.

Preloading an app 26 may involve preloading any app element such as executable code associated with the app, e.g., launch code, app feed, app landing page, various UI elements associated with the app, content associated with the app, app data associated with the app, and/or code or content that is reachable using the app by user actions such as clicks (“in-app content”). Pre-rendering of content may involve background processing of any suitable kind of UI display, or a portion thereof. In Android terminology, for example, pre-rendering may comprise background processing of one or more Android Activities. In the background mode, UI elements associated with the app are not presented to the user on display screen 56, i.e., are hidden from the user. When the user invokes a previously-preloaded app, the user device switches to run the app in a foreground mode that is visible to the user. (The terms “background mode” and “foreground mode” are referred to herein simply as “background” and “foreground,” for brevity.)

The configurations of system 20 and its various elements shown in FIG. 1 are example configurations, which are chosen purely for the sake of conceptual clarity. In alternative embodiments, any other suitable configurations can be used. For example, in some embodiments the preloading tasks may be implemented entirely in processor 44 of user device 24, in which case subsystem 60 may be eliminated altogether.

Preload agent 50 may be implemented in a software module running on processor 44, in an application running on processor 44, in a Software Development Kit (SDK) embedded in an application running on processor 44, as part of the OS running on processor 44 (possibly added to the OS by the user-device vendor or other party), in a proxy server running on processor 44, using a combination of two or more of the above, or in any other suitable manner. In most of the description that follows, preload agent 50 is assumed to be part of OS 48 of user device 24.

Although the embodiments described herein refer mainly to human users, the term “user” refers to machine users, as well. Machine users may comprise, for example, various host systems that use wireless communication, such as in various Internet-of-Things (IoT) applications.

The different elements of system 20 may be implemented using suitable software, using suitable hardware, e.g., using one or more Application-Specific Integrated Circuits (ASICs) or Field-Programmable Gate Arrays (FPGAs), or using a combination of hardware and software elements. Cache 52 may be implemented using one or more memory or storage devices of any suitable type. In some embodiments, preload agent 50 and/or preloading server 60 may be implemented using one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Preload Scheduling Techniques

As noted above, when employing app preloading techniques it is important to schedule the preloading operations correctly. Correct scheduling may involve, for example, choosing which app or apps to preload, and/or deciding on the optimal time and/or the right conditions under which to preload an app. Other possible scheduling decisions have to do with choosing the right preloading mode from among multiple possible modes, e.g., offline preloading in which access to the network is restricted or forbidden, or online preloading in which network access is permitted. Preloading modes are addressed, for example, in PCT International Publication WO 2021/019415, cited above.

The description that follows provides several example preload scheduling techniques, which can be used by OS 48. Some of the disclosed techniques are described as being carried out by preload agent 50 (which runs in OS 48 on processor 44 of user device 24). Some of the disclosed techniques have to do with efficient usage of memory resources in the user device. Such techniques are described as being carried out jointly by preload agent 50 and memory manager 49 (both running on processor 44 of user device 24). Generally, however, the disclosed techniques can be carried out by any processor or processors, in the user device and/or on the network side (e.g., in part or entirely by preload control module 72).

Once scheduled, agent 50 may preload a given app or app component using any suitable preloading technique, such as any of the techniques described in PCT International Publications WO 2018/055506, WO 2021/161174 and WO 2021/019415, cited above.

### Choosing Candidate Apps for Preloading, by Querying the OS

In some embodiments, OS 48 (e.g., Android) may possess information that could be indicative of apps 26 that the user is expected (e.g., likely) to access in the near future. In some embodiments, memory manager 49 in OS 48 queries the OS component that possesses this information to identify one or more such apps, and then invokes preload agent 50 to preload them.

In an example embodiment, the memory manager invokes or otherwise queries a UI feature of the OS that presents a list of suggested apps to the user. One example of such a UI feature is the Android Open Source Project (AOSP) App Suggestion feature. Alternatively, however, any other suitable OS component can be used. The underlying assumption is that the user is relatively likely to access one or more of the suggested apps he/she is presented with. Preloading one or more of the suggested apps reduces the latency experienced by the user when accessing these apps.

In another embodiment, the memory manager itself tracks Least-Recently Used (LRU) user applications. The memory manager triggers agent 50 to preload one or more of the LRU user applications that meets a defined criterion (e.g., apps that were used more recently than a certain time according to the LRU list). The rationale behind this technique is that the user is likely to re-access apps that he/she used recently.

In such an embodiment, the memory manager may track the usage pattern of the various apps 26, by tracking the apps' LRU timestamps of the LRU memory management mechanism (e.g., in memory manager 49). The memory manager may then invoke agent 50 to preload an app if the app was used sufficiently recently, and/or kill an app if the app was not used sufficiently recently.

One of the advantages of this technique is that it enables OS 48 to fully utilize memory 58 of user device 24. For example, when the user kills an app, e.g., by swiping the app off from the Recents screen or in some Oss by using the back button/gesture, memory manager 49 will typically release memory space that was assigned to the app. When using the above technique, memory manager 49 may immediately utilize the free memory space by invoking agent 50 to preload the app back to memory, ready to be instantly displayed on its next launch. Alternatively, the disclosed technique can be implemented in any other suitable way.

In yet another example, the memory manager may query an OS component that prefetches content for apps 26. The memory manager can then invoke agent 50 to preload one or more of the apps for which content was prefetched by the OS component. Alternatively or additionally, agent 50 may incorporate content prefetching within the app preload operation. One non-limiting example of such an OS component is the AOSP setPrefetch Application Programming Interface (API).

This technique improves user experience by eliminating device processing latency, as well as network latency. Moreover, performing preload jointly with prefetch is highly efficient in terms of using the network and the user device's resources.

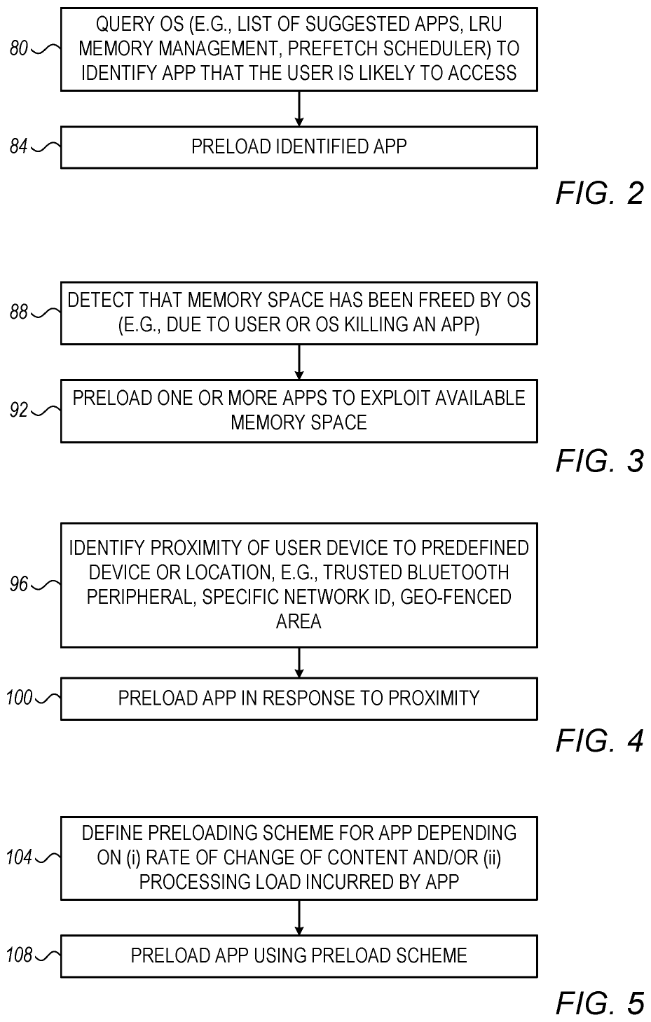

FIG. 2 is a flow chart that schematically illustrates a method for preload scheduling, in accordance with an embodiment of the present invention. At a querying stage 80, memory manager 49 of OS 48 queries a suitable component of OS 48 to identify a list of one or more apps that the user is likely to access in the near future. At a preloading stage 84, the memory manager invokes preload agent 48 to preload one or more of the apps on the list.

The OS components described above (e.g., App suggestion, LRU memory management, prefetch scheduling) are chosen purely by way of example. In alternative embodiments, the memory manager may query any other suitable element of OS 48 in order to identify apps that the user is likely to access.

### Preloading Apps to Exploit Free Memory Space

In some embodiments, memory manager 49 continually monitors the utilization of memory 58. When detecting free (i.e., unused) memory space, memory manager 49 invokes preload agent 50 to preload one or more apps. This process aims to populate memory 58 with preloaded apps to the largest extent possible. The apps being preloaded may be the apps that the OS estimates are most likely to be accessed by the user in the near future.

In example embodiments, memory manager 49 detects that space in memory 58 has been freed without being immediately reclaimed. Memory manager 49 then invokes preload agent 50 to preload one or more apps 26 so as to exploit at least some of the freed memory space. This technique makes efficient use of the user device memory, putting the free memory space to productive use.

Consider, for example, a scenario in which the user kills an app that is currently in the background. The user may kill a background app, for example, by swiping it off from the Recents screen. For an app that is currently live in the memory, the user may kill the app by swiping it off from the Recents screen or by using the back button/gesture. Such an action causes the memory manager to release memory space in memory 58 that was previously allocated to the app.

In an embodiment, memory manager 49 may respond to the release of memory by requesting agent 50 to preload one or more apps 26 to exploit at least some of the available memory space with storage of useful content. The app to be preloaded may be the same app that was killed, under the assumption that the user is likely to reuse it soon, or any other apps that the user is likely to access.

In another example scenario, OS 48 may decide to kill an app that is in a background state on its own initiative (i.e., not in response to the user requesting to kill the app). The OS may decide to kill an app, e.g., due to memory shortage. In some embodiments, memory manager 49 may respond to this event by invoking agent 50 to preload the same app whenever memory space is available.

In an embodiment, agent 50 will preload the app to the state it was in before it was killed. Preloading techniques of this sort are given, for example, in PCT International Publications WO 2018/055506, WO 2021/161174 and WO 2021/019415, cited above. As a result, the background app will be launched immediately when accessed by the user.

Another scenario in which the OS kills an app may occur when the app is subject to software updates, e.g., updates to the app code for new features, bug fixes, security fixes and synchronization with external protocols. In such a case, the OS would typically kill the app process and activities. In some embodiments, agent 50 may detect this event by querying the OS, and immediately preload the software-updated version of the app. This feature would preserve the latency-free response of a backgrounded app.

In yet another scenario, user device 24 may be occasionally shut-down, e.g., by the user in order to fix issues or to conserve battery, or by the OS due to low battery or due to an OS software update. After restarting the user device, no app activities are typically alive aside from OS navigation elements such as the selected launcher app. In some embodiments, following restart, preload agent 50 may preload some or all of the activities that were alive before the user device was shut down. This technique would provide a smoother latency-free user experience after restart.

The above embodiments provide several non-limiting examples of scenarios in which memory space becomes available, and this fact is detected and utilized for preloading. The preloading operation thus uses the otherwise-wasted memory space for enhancing user experience. In alternative embodiments, this technique (exploiting unused memory space for preloading) can be used in any other suitable scenario.

FIG. 3 is a flow chart that schematically illustrates a method for preload scheduling, in accordance with another embodiment of the present invention. At a detection stage, memory manager 49 detects that memory space became available in memory 58. At a preloading stage 92, memory manager 49 invokes agent 50 to preload one or more apps 26 to exploit at least some of the available memory space.

### Preloading in Response to Proximity to Peripheral, Network or Service

In some embodiments, OS 48 may invoke agent 50 to preload an app in response to detecting that user device 24 is in proximity to a predefined device. The predefined device may comprise, for example, a wired or wireless peripheral that user device 24 can connect to, a predefined network identity, a certain local service that user device 24 can connect to, and the like.

Typically, the app or apps being preloaded are chosen because they are associated with the device (to which user device 24 is in proximity). For example, OS 48 may decide to preload one or more apps that are likely to be used by the user when in proximity to the device in question.

For example, OS 48 may detect that user device 24 has connected to a pre-specified trusted Bluetooth peripheral. In response, the OS may invoke agent 50 to preload an app that is expected to make use of this peripheral, e.g., a music player.

As another example, upon detecting that user device 24 has entered a predefined location, e.g., by detecting entry to a geo-fenced area or by detecting connection to a predefined network, OS 48 may decide to trigger agent 50 to preload an associated app (e.g., preload a smart-home control app when the user device is in proximity to the user's home, preload a music player when the user device is in proximity to a gym or train station, preloading an attendance report app when the user device is in proximity to the user's work place, etc.)

FIG. 4 is a flow chart that schematically illustrates a method for preload scheduling, in accordance with yet another embodiment of the present invention. At a detection stage 96, OS 48 detects that user device 24 is in proximity to a predefined device or location. At a preloading stage 100, OS 48 invokes agent 50 to preload one or more apps 26 that the user is likely to access while in proximity to the predefined device.

### Preloading Schemes for Preserving Network and User Device Resources

In various embodiments, agent 50 may define a specific preloading scheme for preloading a certain app 26. The preloading scheme depends on the characteristics of the app, and aims to minimize the resulting cost in using the network and/or the user device resources.

In some embodiments, the preloading scheme makes use of different preloading modes. For example, PCT International Publication WO 2021/019415, cited above, describes an “offline preloading mode” and an “online preloading mode”. In the offline mode, access to the network is restricted or forbidden, meaning that agent 50 is only permitted to preload content that resides locally in user device 24 (e.g., as a result of prefetching or prior use). Offline preloading reduces network communication and the associated data cost. In the online mode network access is permitted as needed. In various embodiments, an efficient preloading scheme for an app may be devised by a suitable combination of the online and offline modes.

Consider, for example, an app whose content changes rapidly over time (e.g., with a rate-of-change that is above a threshold), such as a news app. An efficient preloading scheme for this sort of app may preload only the app's initialization logic, e.g., using offline preloading, in order to reduce device processing latency, and possibly apply in-app preloading only when the user activates the app in order to eliminate network latency.

As another example, consider an app that requires heavy in-device processing (e.g., has an initialization phase that incurs a processing load above a threshold) but whose content changes relatively infrequently. Some gaming apps, for example, have these characteristics. For such an app, agent 50 may define a preloading scheme that renders in-device content, e.g., using offline preloading, in order to eliminate device processing latency. The preloading scheme may apply online preloading only occasionally, preferably under favorable network and user device conditions, in an attempt to eliminate network latency associated with content updates.

As yet another example, consider apps having incremental content changes such as email or social network apps. Since the wasted bandwidth would typically be minimal due to the incremental nature of the content, an efficient preloading scheme for such an app would apply online preloading in order to eliminate content load latency, preferably under favorable network and device conditions, allowing the user device to display new content every time the user activates the app. For apps that have implemented an offline-first experience, an efficient preloading scheme may render cached content, e.g., via offline preloading, in order to eliminate in-device processing latency.

The above apps and corresponding preloading schemes are non-limiting examples. In alternative embodiments, agent 50 may define and apply any other suitable preloading scheme for preloading a certain app. Typically, although not necessarily, the preloading scheme is defined to match the characteristics of the app, e.g., the rate of change of content used by the app and/or the amount of processing incurred by the app.

In various embodiments, agent 50 may assess the rate of change of content used by the app and/or the amount of processing incurred by the app in any suitable way. For example, such information may be declared by the app, or agent 50 may learn the information from past behavior of the app. As another example, agent 50 may predefine these values based on the app's category (such as a category in the app store—games, news apps, etc.)

FIG. 5 is a flow chart that schematically illustrates a method for preloading, in accordance with another embodiment of the present invention. At a preloading scheme definition stage 104, preload agent 50 defines a preloading scheme for a specific app. The preloading scheme depends on the rate of change of the content used by the app and/or on the amount of processing incurred by the app in the user device. At a preloading stage 108, agent 50 preloads the app using the defined preloading scheme.

Another way to conserve network and user device resources (e.g., wireless modem and CPU resources in the user device) is to combine different app preloading operations with one another whenever possible.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A user device, comprising:
an output device; and
one or more processors, configured to:
run an Operating System (OS);
query a component of the OS, which possesses information indicative of a user application that the user is currently expected to access; and
preload the user application in a background mode that is unnoticeable on the output device.

2. The user device according to claim 1, wherein the OS component is a component that presents to the user a list of suggested user applications, and wherein the user application is one of the suggested user applications.

3. The user device according to claim 1, wherein the OS component is a memory management component of the OS that tracks Least-Recently Used (LRU) user applications, and wherein the user application is one of the LRU user applications that meets a defined criterion.

4. The user device according to claim 1, wherein the OS component is a component that prefetches content for user applications, and wherein the user application is one of the user applications for which content is prefetched by the OS component.

5. A user device, comprising:
a memory; and
one or more processors, configured to:
detect unused memory space that is available in the memory; and
preload one or more user applications to exploit at least some of the unused memory space in the memory.

6. The user device according to claim 5, wherein the one or more processors are configured to detect the unused memory space by detecting that a user has killed a user application.

7. A user device, comprising:
an output device; and
one or more processors, configured to:
identify a proximity of the user device to a given device or location; and
responsively to the identified proximity, preload a given user application in a background mode that is unnoticeable on the output device.

8. The user device according to claim 7, wherein the one or more processors are configured to identify the proximity by detecting that the user device connects to a trusted peripheral device.

9. The user device according to claim 7, wherein the one or more processors are configured to identify the proximity by detecting that the user device connects to a specified network identity.

10. The user device according to claim 7, wherein the one or more processors are configured to identify the proximity by querying a geofencing service in the user device.

11. A user device, comprising:
an output device; and
one or more processors, configured to:
define a preloading scheme for a user application installed on the user device, depending on one or both of (i) a rate of change of content used by the user application, and (ii) an amount of processing load incurred by the user application; and
preload the user application, in a background mode that is unnoticeable on the output device, using the defined preloading scheme.

12. The user device according to claim 11, wherein the one or more processors are configured to preload only a part of the user application in which the rate of change of the content is below a threshold.

13. The user device according to claim 11, wherein the one or more processors are configured to preload the user application using a combination of an offline preloading mode and an online preloading mode.

14. The user device according to claim 11, wherein the user application is characterized by a rate of change higher than a threshold, and wherein the one or more processors are configured to preload only an initialization logic of the user application.

15. The user device according to claim 11, wherein the user application comprises an initialization phase whose processing load is above a threshold, and wherein the one or more processors are configured to preload the user application using an offline preloading mode.

16. The user device according to claim 11, wherein the user application is characterized by incremental content updates, and wherein the one or more processors are configured to preload the user application using an online preloading mode.

17. The user device according to claim 11, wherein the user application comprises an offline-first experience, and wherein the one or more processors are configured to preload the user application using an offline preloading mode.

18. A user device, comprising:
a memory; and
one or more processors, configured to run an Operating System (OS), which comprises:
a preload agent, configured to preload user applications; and
a memory manager, configured to:
select one or more user applications to be retained in the memory based on, at least in part, preloading capabilities of the OS; and
load the selected user applications to the memory, including, upon deciding to preload a given user application, invoking the preload agent to preload the given user application.

19. A method, comprising:
in a user device that comprises an output device and that runs an Operating System (OS), querying a component of the OS, which possesses information indicative of a user application that the user is currently expected to access; and
preloading the user application in a background mode that is unnoticeable on the output device.

20. The method according to claim 19, wherein querying the OS component comprises querying a component that presents to the user a list of suggested user applications, and wherein the user application is one of the suggested user applications.

21. The method according to claim 19, wherein querying the OS component comprises querying a memory management component of the OS that tracks Least-Recently Used (LRU) user applications, and wherein the user application is one of the LRU user applications that meets a defined criterion.

22. The method according to claim 19, wherein querying the OS component comprises querying a component that prefetches content for user applications, and wherein the user application is one of the user applications for which content is prefetched by the OS component.

23. A method, comprising:
in a user device, detecting unused memory space that is available in a memory of the user device; and
preloading one or more user applications to exploit at least some of the unused memory space in the memory.

24. The method according to claim 23, wherein detecting the unused memory space comprises detecting that a user has killed a user application.

25. A method, comprising:
in a user device that comprises an output device, identifying a proximity of the user device to a given device or location; and
responsively to the identified proximity, preloading a given user application in a background mode that is unnoticeable on the output device.

26. The method according to claim 25, wherein identifying the proximity comprises detecting that the user device connects to a trusted peripheral device.

27. The method according to claim 25, wherein identifying the proximity comprises detecting that the user device connects to a specified network identity.

28. The method according to claim 25, wherein identifying the proximity comprises querying a geofencing service in the user device.

29. A method, comprising:
in a user device that comprises an output device, defining a preloading scheme for a user application installed on the user device, depending on one or both of (i) a rate of change of content used by the user application, and (ii) an amount of processing load incurred by the user application; and
preloading the user application, in a background mode that is unnoticeable on the output device, using the defined preloading scheme.

30. The method according to claim 29, wherein preloading the user application comprises preloading only a part of the user application in which the rate of change of the content is below a threshold.

31. The method according to claim 29, wherein preloading the user application comprises preloading the user application using a combination of an offline preloading mode and an online preloading mode.

32. The method according to claim 29, wherein the user application is characterized by a rate of change higher than a threshold, and wherein preloading the user application comprises preloading only an initialization logic of the user application.

33. The method according to claim 29, wherein the user application comprises an initialization phase whose processing load is above a threshold, and wherein preloading the user application comprises preloading the user application using an offline preloading mode.

34. The method according to claim 29, wherein the user application is characterized by incremental content updates, and wherein preloading the user application comprises preloading the user application using an online preloading mode.

35. The method according to claim 29, wherein the user application comprises an offline-first experience, and wherein preloading the user application comprises preloading the user application using an offline preloading mode.

36. A method, comprising:
in a user device that comprises a memory and runs an Operating System (OS), running in the OS a preload agent that preloads user applications; and
further running in the OS a memory manager, including:
selecting one or more user applications to be retained in the memory based on, at least in part, preloading capabilities of the OS; and
loading the selected user applications to the memory, including, upon deciding to preload a given user application, invoking the preload agent to preload the given user application.
